(19) United States
(12) Patent Application Publication
(10) Pub. No.: US 2016/0192765 A1
(43) Pub. Date: Jul. 7, 2016

(54) Beverage Container Support Assembly

(71) Applicant: Shad Pease, Hamilton, MT (US)

(72) Inventor: Shad Pease, Hamilton, MT (US)

(21) Appl. No.: 14/990,783

(22) Filed: Jan. 7, 2016

Related U.S. Application Data
(60) Provisional application No. 62/100,655, filed on Jan. 7, 2015.

(51) Int. Cl. A45F 5/00; B60N 3/10

(52) U.S. Cl. CPC A45F 5/00; B60N 3/103; B60N 3/108; A45F 2200/0583

(57) ABSTRACT

A beverage support assembly is provided for safely supporting bottles within a vehicle in a suspended state from an external support. The assembly has a support means and an attachment means such as a hook. The assembly can be utilized for holding a bottle from a location within a vehicle, thereby preventing the bottle from moving around to unwanted locations within the vehicle. The assembly accommodates beverage bottles of various sizes with a unique adjustable design, and includes space for printed logos or additional advertising.

### CROSS-REFERENCES TO RELATED APPLICATIONS

This application is the non-provisional application claiming the priority date of provisional application 62/100,655 filed Jan. 7, 2015.

### BACKGROUND

This invention relates to the field of beverage container supports more specifically one that can be used with today's vehicles.

Today plastic soda and water bottles come in a variety of shapes and sizes. Unfortunately, most cup holders within today's vehicles do not accommodate these containers. Their shallow, one -size-fits-all depressions are not at all suited for all container sizes and sometimes allow beverages to topple over while the vehicle is in operation. This can be distracting to drivers, cause spills within the vehicle interior, or even risk having the beverage interfere with the foot pedals of the vehicle if allowed to roll onto the vehicle floor. These problems extend beyond motor vehicle applications, as supporting a beverage in other environments can also be problematic.

Devices exist in the art related to bottle holders. These include spring bottle holders and those with L-shaped support rods that hold a pair of joined springs to support a bottle holder. These prior art devices, however, fail to provide a bottle clip support assembly that encircles a beverage container and supports the bottle from an exposed overhang or ledge.

There is still room for improvement in the art.

### SUMMARY

The current invention is a beverage support assembly device to provide for the safe supporting of bottles within a vehicle in a suspended state from an external support. The device includes an attachment means such as a hook that supports a bottle clip configured to encircle a supported bottle there around. The bottle clip includes an expandable loop to hold the bottle. The assembly can be utilized for holding a bottle from a location within a vehicle, thereby preventing the bottle from moving around to unwanted locations within the vehicle.

Overall, the present invention provides convenient access to a bottle beverage virtually anywhere, and prevents beverages from spilling over in vehicles or becoming wedged under the pedals. When used outside of a vehicle environment, the assembly frees up table, desk, or countertop space by suspending the beverage from an exposed ledge. The assembly accommodates beverage bottles of various sizes with a unique adjustable design, and includes space for printed logos or additional advertising.

### BRIEF DESCRIPTION OF THE DRAWINGS

Embodiments of the device in accordance with the present disclosure will be described with reference to the drawings, in which:

FIG. 1 shows the device holding a beverage within a vehicle;

FIG. 2 shows the device by itself used in an office setting;

FIG. 3 shows how the device can accommodate bottles of different sizes; and

FIG. 4 shows an alternative embodiment of the device.

### DETAILED DESCRIPTION

The subject embodiments of the present invention are described here with specificity to meet statutory requirements, but this description is not necessarily intended to limit the scope of the claims.

Embodiments of the device will be described more fully hereinafter with reference to the accompanying drawings, which form a part hereof, and which show, by way of illustration, embodiments of this device.

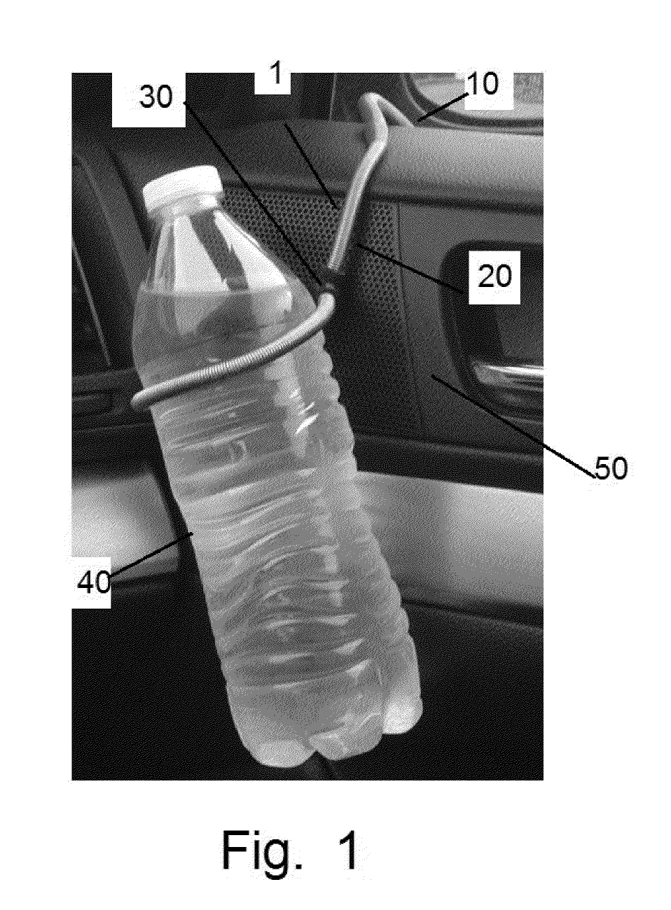

The current invention is a beverage support assembly 1 to provide for the safe supporting of bottles 40 within a vehicle 50 or to furniture or to a book bag or similar location in a suspended state from an external support as shown in FIG. 1. This shows the beverage container support assembly 1 is in a working state in a vehicle.

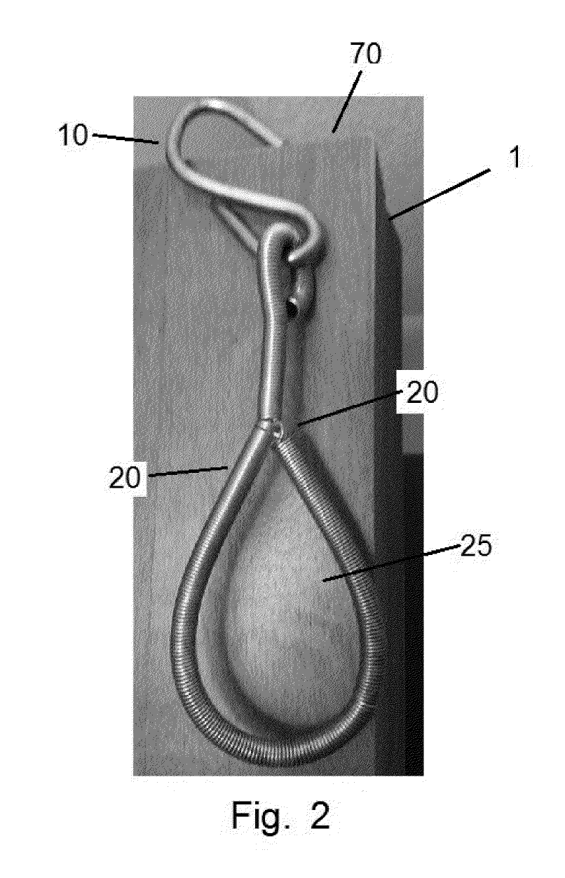

As show in FIG. 2, the main components of the beverage container support assembly 1 are an attachment means 10 such as a hook or a clamp, a support means 20 such as a cable or a wire material or spring and a securing means 30 such as a T-clip or hook.

The beverage container support assembly 1 comprises a support means 20 that attaches to an attachment means 10 on one end and a securing means 30 on the other. The securing means forms a closed loop 25 by attaching back to the support means 20. The support means 20 can be comprised of a wire material or cable or elastic material that can be expanded or contracted to change the size of its circular shape, thereby encircling and conforming to the exterior of different beverage containers 40.

The attachment means 10 in the preferred embodiment is a hook or an S-hook. The hook includes an exposed hook which engages the support means. In this manner, the support means 20 secures to the beverage, and the hook secures to an exposed ledge and supports the beverage container 40 in a suspended state. The attachment means 10 and the support means 20 are rotatable relative to one another, such that the beverage container 40 can sway slightly as a vehicle changes movement or when a user rearranges the position of the beverage container 40.

The securing means 30 is placed over a beverage container 40 and sized to clamp around its exterior perimeter using a securing hook 35 to connect to the support means 20 where the hook is located at the end of the support means 20 and the support means 20 is compressed against the walls of the beverage such that the beverage is snugly supported therein. In this embodiment, the support means 20 will be made of a spring or coiled material or have slots for the securing hook 35 to connect to.

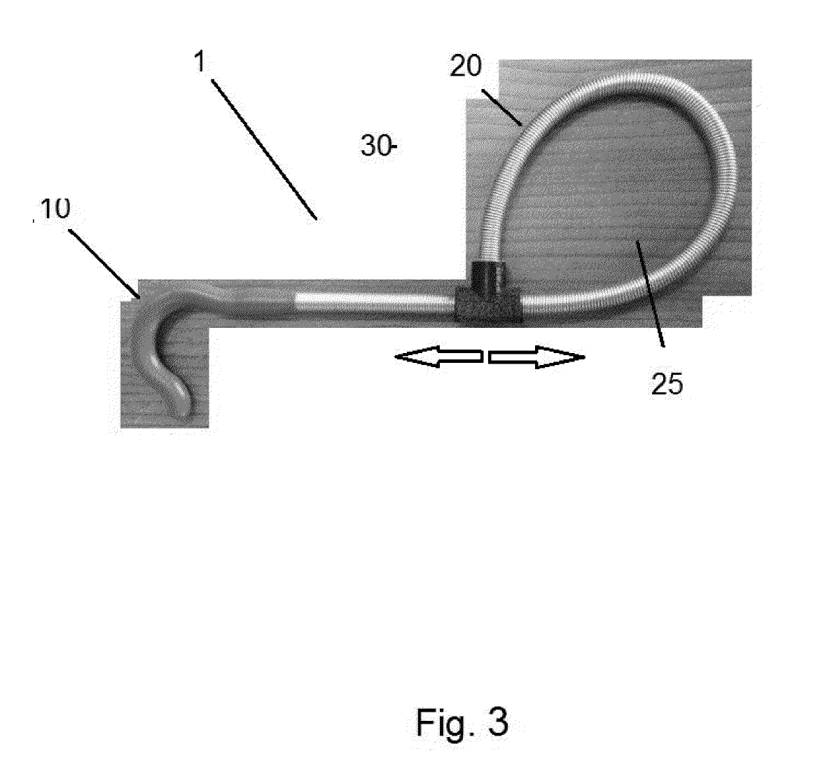

Referring now to FIG. 3, the hook supports the support means 20 and the securing means 30 is movable moving up and down the support means 20 to form the closed loop 25 securely around the perimeter of the beverage container 40. It provides an interior area within which the beverage can be inserted and supported.

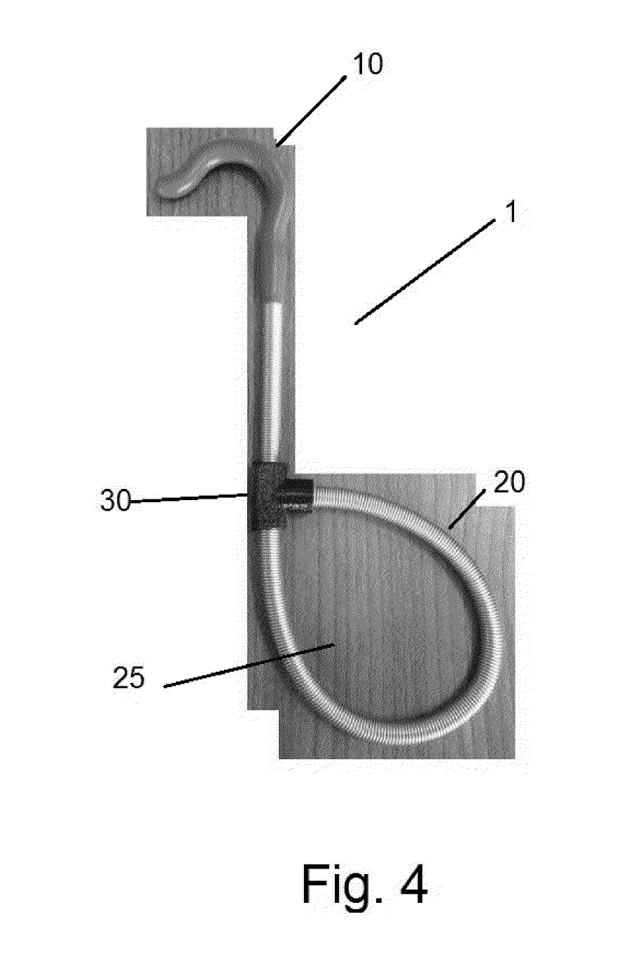

FIG. 4 shows an alternative embodiment where the securing means 30 is in the shape of a “T” with the support means 20 running through a channel at the top of the T and attached to the straight end of the T. In this embodiment, the securing means 30 is held in place by friction caused a tight fit of the support means 20 in the channel where the diameter of the channel is only slightly larger than the diameter of the support means 20 with the surface of the channel causing friction between it and the surface of the support means 20. The securing means 30 can also have a locking mechanism such as a tightening means such as a screw or clamping mechanism to secure the securing means in place on the support means.

FIG. 2 also shows the assembly 1 supporting a beverage 40 from an article of furniture 70. The assembly 1 secures the most common plastic beverage containers 40. The assembly 1 can be used to secure a beverage container 40 to any item or location where the attachment means 10 can connect to.

The assembly can be offered in assorted colors with company logos for enhanced advertising.

In an additional embodiment, the securing means 30 can actually be a fixed connections to the support means 20 with the closed loop 25 being comprised of an elastic material which is expanded and placed around the beverage container 40 securing it.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

What is claimed is:

1. A beverage container support device, comprising: an attachment means connected to a support means which is connected to a securing means where said securing means attaches to the end of the support means and the middle of the support means to form a loop.

2. A device according to claim 1 further comprising the attachment means being a hook.

3. A device according to claim 1 further comprising where the securing means is a hook.

4. A device according to claim 1 further comprising where the support means is elastic.

5. A device according to claim 1 further comprising where the securing means is attached to the support at a fixed location.

6. A device according to claim 1 further comprising where the securing means has a channel where the support means runs through.

7. A device according to claim 6 further comprising where the securing means is in the shape of a “T”.

8. A device according to claim 1 further comprising where the support means is a cable.

9. A device according to claim 1 further comprising where the support means is a wire cable.

10. A device according to claim 1 further comprising where the securing means forms a closed loop by attaching to the middle of the support means which secures the container.

11. A method to support a beverage container comprising: support device with an attachment means connected to a support means which is connected to a securing means where said securing means attaches to the end of the support means and the middle of the support means to form a loop.

12. A method according to claim 11 further comprising the attachment means being a hook.

13. A method according to claim 11 further comprising where the securing means is a hook.

14. A method according to claim 11 further comprising where the support means is elastic.

15. A method according to claim 11 further comprising where the securing means is attached to the support at a fixed location.

16. A method according to claim 11 further comprising where the securing means has a channel where the support means runs through.

17. A method according to claim 16 further comprising where the securing means is in the shape of a “T”.

18. A method according to claim 11 further comprising where the support means is a cable.

19. A method according to claim 11 further comprising where the support means is a wire cable.

20. A method according to claim 11 further comprising where the securing means forms a closed loop by attaching to the middle of the support means which secures the container.
